(19) United States
(12) Patent Application Publication
(10) Pub. No.: US 2009/0198037 A1
(43) Pub. Date: Aug. 6, 2009

(54) NORBORNENE-BASED POLYMER, FILM CONTAINING THE SAME, POLARIZING PLATE, AND LIQUID CRYSTAL DISPLAY DEVICE

(75) Inventor: Saisuke Watanabe, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/363,160

(22) Filed: Jan. 30, 2009

(30) Foreign Application Priority Data
Jan. 31, 2008 (JP) 2008-021378

(51) Int. Cl. C08G 61/02; C08G 63/02

(52) U.S. Cl. 528/271; 528/396

(57) ABSTRACT

A norbornene based polymer is provided. The norbornene-based polymer includes a repeating unit represented by formula (I) in an amount of from 0.01 to 2.00 mol % based on a total amount of repeating units:

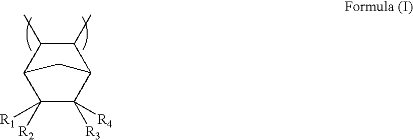

wherein R¹, R², R³ and R⁴ each independently represents a hydrogen atom, a halogen atom, a methyl group, or an aryl group which may have a substituent, provided that at least one of R¹, R², R³ and R⁴ represents aryl group.

### BACKGROUND OF THE INVENTION

1. Field of the Invention

The present invention relates to a norbornene-based polymer, a film (particularly, a retardation film, a viewing angle widening film, various functional films such as an antireflection film for use in an image display screen, or a polarizing plate protective film ) using the same, a polarizing plate, and a liquid crystal display device.

2. Description of the Related Art

A film of a norbornene-based addition polymer obtained from vinyl polymerization of a norbornene-based compound (which is hereinafter also referred to as a norbornene-based polymer) has a feature of high retardation in the direction of thickness (Rth), and hence is applicable to a negative C plate (international Publication WO 04/007564 and WO 04/007587). Further, by stretching this, the main chains of the norbornene-based polymer are aligned in the direction of stretching. Thus, the film exhibits in-plate retardation (Re), and is applicable to a negative biaxial phase anisotropic plate. Namely, the film of the norbornene-based polymer is promising as a retardation film having high Re and Rth. Particularly, it is preferable as a retardation film of a liquid crystal display device of a VA system (vertical alignment system) (International Publication WO 05/066703).

The norbornene-based polymer has a glass transition point of more than two hundreds and several tens degrees. For this reason, it is difficult to melt the polymer and to manufacture a film. Therefore, generally, the following solution film formation method is adopted: the norbornene-based polymer is dissolved in a proper solvent such as methylene chloride (a nonflammable solvent is preferable from the viewpoint of explosion protection), resulting in a dope; and this is cast over a metal support.

In the solution film formation, when the peelability (peel load) is inferior in the step of peeling the film after casting of the dope over the support, the surface conditions of the film reflect the unevenness during peeling, and are deteriorated. The peelability results from the property of the material for the film itself. Therefore, in order to enhance the productivity of the film, it is important to select a good material (JP-A-2006-321835).

### SUMMARY OF THE INVENTION

The study conducted by the present inventor indicates that the conventionally known norbornene-based polymers described in International Publication WO 04/007564 and WO 04/007587, and the like produce low peelability, and are not enough for enhancing the surface conditions of the film. Therefore, there has been a demand for improvement into a norbornene-based polymer capable of being improved in peelability.

The present inventor has conducted a close study, and as a result, finds out the following: by copolymerizing aryl group-containing norbornene-based monomers into norbornene-based polymer, the peelability during film manufacturing is improved than that of the original norbornene-based polymer under the influence of the interaction thereof. Thus, the amount of the aryl group to be introduced was changed. As a result, the present inventors found out that, surprisingly, the aryl group even in an amount as small as 0.01 mol % to 2.00 mol % produces an effect of the improvement of the peelability. This has led to the invention.

That is, the present invention is as follows:

(1) A norbornene-based polymer, comprising:

a repeating unit represented by formula (I) in an amount of from 0.01 to 2.00 mol % based on a total amount of repeating units:

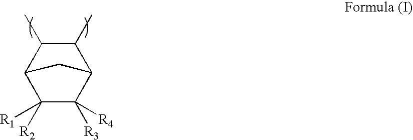

wherein R¹, R², R³ and R⁴ each independently represents a hydrogen atom, a halogen atom, a methyl group, or an aryl group which may have a substituent, provided that at least one of R¹, R², R³ and R⁴ represents aryl group.

(2) The norbornene-based polymer according to claim 1, further comprising:

a repeating unit represented by formula (II) in an amount of from 98.00 to 99.99 mol % based on a total amount of repeating units:

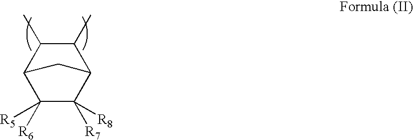

wherein R⁵, R⁶, R⁷ and R⁸ each independently represents a hydrogen atom or a functional substituent selected from the group consisting of —(CH₂)ₘ—OC(O)—R″, —(CH₂)ₘ—OH, —(CH₂)ₘ—C(O)—OH, —(CH₂)ₘ—C(O)OR″, —(CH₂)ₘ—OR″, —(CH₂)ₘ—OC(O)OR″, —(CH₂)ₘ—C(O)R″, and —(CH₂)ₘ—O—(CH₂)_{m′}—OH, where m and m′ independently represent 0 to 10, R″ represents a linear or branched alkyl group having from 1 to 10 carbon atoms, and R⁵ and R⁸ may form an anhydride or a dicarboxyimide group together with ring member carbon atoms to which R⁵ and R⁸ are attached, provided that at least one of R⁵, R⁶, R⁷ and R⁸ represents the functional substituent.

(3) The norbornene-based polymer according to item (1) or (2),

wherein R¹, R², R³, and R⁴ in the formula (I) each independently represents a hydrogen atom or a phenyl group, and at least one of R¹, R², R³, and R⁴ represents a phenyl group.

(4) The norbornene-based polymer according to any of items (1) to (3),

wherein R⁵, R⁶, R⁷, and R⁸ in the formula (II) each independently represents a hydrogen atom or —CH₂—OC(O)—R″, and at least one of R⁵, R⁶, R⁷, and R⁸ is —CH₂—OC(O)—R″, where R″ represents a linear or branched alkyl group having from 1 to 10 carbon atoms.

(5) A film comprising the norbornene-based polymer according to any of items (1) to (4).

(6) The film according to item (S), satisfying the following expression:

30 nm≦Re₅₉₀≦200 nm

wherein Re₅₉₀ represents an in-plane retardation at a wavelength of 590 nm.

(7) A polarizing plate comprising:

a polarizing film; and a film according to tern (5) or (6).

(8) A liquid crystal display device comprising a polarizing plate according to item (7).

(9) The norbornene-based polymer according to item (3),

wherein one of R¹, R², R³, and R⁴ in the formula (I) represents a phenyl group.

### DETAILED DESCRIPTION OF THE INVENTION

### (Norbornene-Based Polymer)

A norbornene-based polymer in the invention is a homopolymer resulting from addition polymerization of one kind of a norbornene-based compound, or a copolymer resulting from addition polymerization of two or more kinds of norbornene-based compounds.

The norbornene-based polymer in the invention contains, in order to improve the peelability during film manufacturing, a repeating unit derived from a norbornene-based monomer containing a trace amount of aryl group, namely, the skeleton of the formula (I):

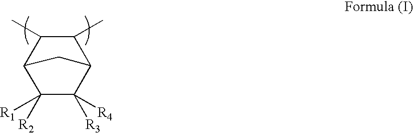

(where in the formula, R¹, R², R³, and R⁴ each independently represents a hydrogen atom, a halogen atom, a methyl group, or an aryl group which may have a substituent; and at least one of R¹, R², R³, and R⁴ represents the aryl group.)

The aryl groups may includes, but is not limited to one hydrogen atom removed products of the following aromatic compounds. Further, the aromatic compounds each may have a given substituent.

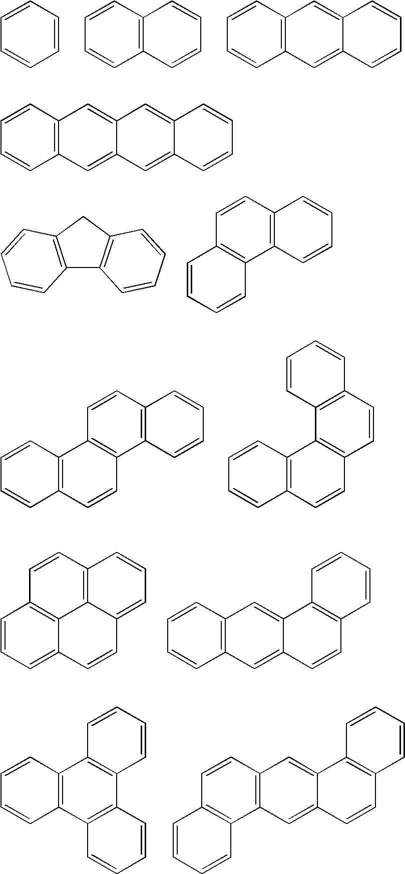

R¹, R², R³, and R⁴ are each preferably a hydrogen atom or an unsubstituted aryl group, and further preferably a hydrogen atom or a phenyl group from the viewpoint of availability of the monomers.

Particularly, the skeleton of the formula (I) is preferably a skeleton derived from phenyl norbornene formed from styrene and cyclopentadiene from the viewpoint of the general versatility of the monomers. Therefore, preferably, one of R¹, R², R³, and R⁴ is a phenyl group, and each remaining one is hydrogen.

The stereochemistries of the phenyl group include two kinds of endo and exo, which may be used alone or in a mixture thereof. With the Diels-Alder reaction, the endo form generally becomes a mixture of main products, which may be used as it is.

In the invention, the repeating unit represented by the formula (I) is contained in an amount of 0.01 to 2.00 mol % based on the total amount of the structural units. Due to the presence of the repeating unit represented by the formula (I) contained therein in amount of 0.01 to 2.00 mol %, the peelability of the film is improved than that of the norbornene-based polymer not containing the repeating unit represented by the formula (I). When the content is larger than 0.01%, peelability of the film is more effective. Whereas, when the content is less than 2.00%, the value of Rth does not increases, and the film physical properties are not affected. Therefore, the main structural unit of the norbornene-based polymer in the present invention is preferably a norbornene-based monomer other than the norbornene-based monomer of the formula (I). The norbornene-based polymer of the main structural unit may be either a homopolymer or a copolymer.

The preferable norbornene-based polymer serving as the main structural unit in the invention is represented by the following formula (II). The unit is preferably contained in an amount of 98.00 to 99.99 mol % based on the total amount of the repeating units.

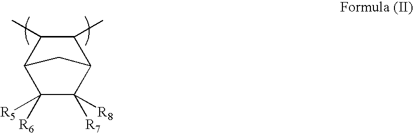

(where in the formula, R⁵, R⁶, R⁷, and R⁸ are each independently a hydrogen atom, or a functional substituent selected from the group consisting of —(CH₂)ₘ—OC(O)—R″, —(CH₂)ₘ—OH, —(CH₂)ₘ—C(O)—OH, —(CH₂)ₘ—C(O)OR, —(CH₂)ₘ—OR−, —(CH₂)ₘ—OC(O)OR−, —(CH₂)ₘ—C(O)R″, and —(CH₂)ₘ —O—(CH₂)_{m′}—OH, where m and m′ independently represent 0 to 10, R″ represents a linear or branched (C₁ to C₁₀) alkyl group, and R⁵ and R⁸ can form an anhydride or a dicarboxyimide group together with ring member carbon atoms to which they are attached, and at least one of R⁵ to R⁸ represents the functional substituent.)

The monomer can be obtained from the Diels-Alder reaction of cyclopentadiene and the corresponding olefin. Therefore, from the viewpoint of the general versatility of the corresponding olefin, the functional group is preferably —(CH₂)ₘ—OC(O)—R″, —(CH₂)ₘ—OH, —(CH₂)ₘ—C(O)—OH, —(CH₂)ₘ—C(O)OR″, —(CH₂)ₘ—OR″, and —(CH₂)ₘOR″. Further, from the viewpoint of the polymer synthesis of monomers, the functional substituent is further preferably —(CH₂)ₘ—OC(O)—R″, —(CH₂)ₘ—C(O)OR″, and —(CH₂)ₘ—OR″, and most preferably —(CH₂)ₘ—OC(O)—R″ and —(CH₂)ₘ—C(O)OR″.

As for m, m′, and R″, from the viewpoint of reducing the photoelasticity of the film, the number of carbon atoms is preferably smaller. However, from the viewpoint of reducing the glass transition point of the polymer, the number of carbon atoms is preferably larger. In view of both the points, for R″, the number of carbon atoms is preferably 1 to 6, further preferably 1 to 3, and most preferably 1 to 2. For m and m′, similarly, the number of carbon atoms is preferably 1 to 5, further preferably 1 to 3, and most preferably 1 to 2.

The stereochemistries of the functional substituent include two kinds of endo and exo, which may be used alone or in a mixture thereof With the Diels-Alder reaction, the endo form generally becomes a mixture of main products, which may be used as it is.

Specific examples of the repeating unit represented by the formula (II) will be shown below. However, the invention is not limited to these.

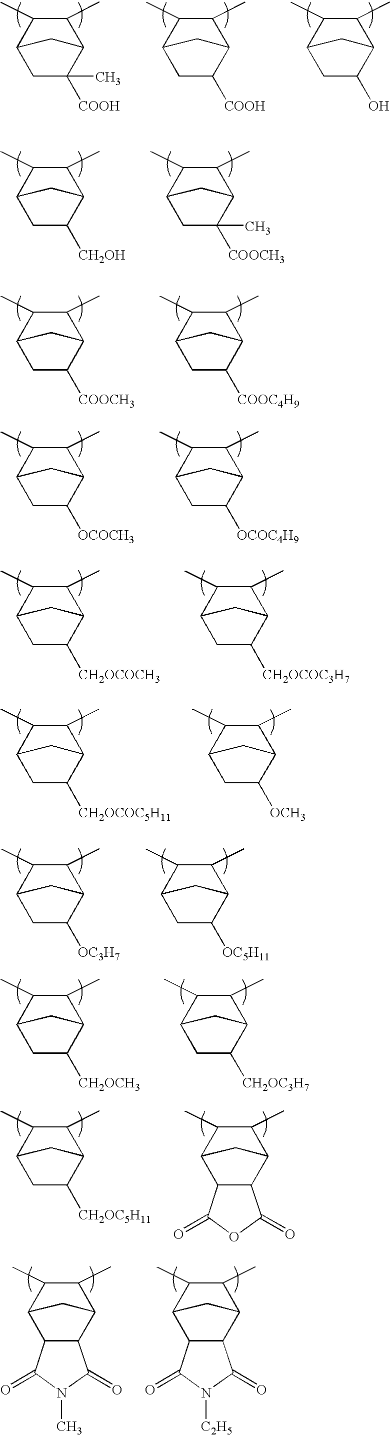

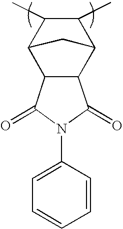

Below, preferred examples of the norbornene-based polymer of the invention containing the repeating unit represented by the formula (I) and the repeating unit represented by the formula (II). However, the invention is not limited thereto. Incidentally, the numerical value at the upper right side of parentheses denotes the ratio of copolymerization.

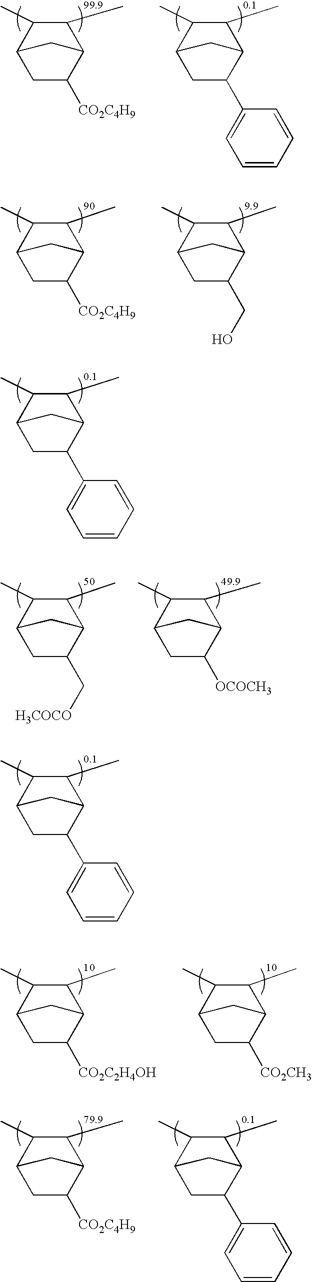

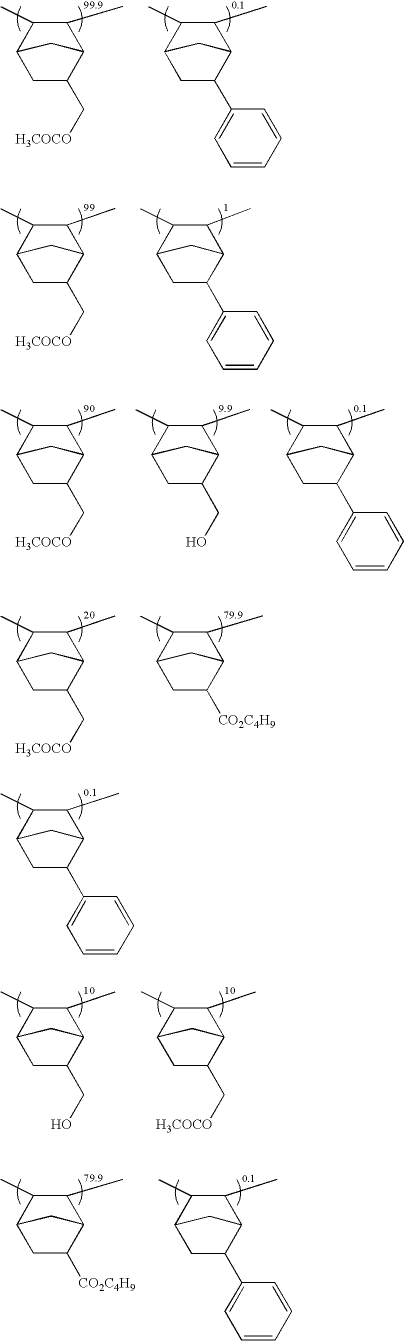

For the norbornene-based polymer of the invention, the number average molecular weight measured by gel permeation chromatography using tetrahydrofuran as a solvent is preferably 10,000 to 1,000,000, and more preferably 50,000 to 500,000. Whereas, the polystyrene equivalent weight average molecular weight is preferably 15,000 to 1,500,000, and more preferably 70,000 to 700,000. When the polystyrene equivalent number average molecular weight is 10,000 or more, and the polystyrene equivalent weight average molecular weight is 15,000 or more, the fracture strength tends to be more preferable. When the polystyrene equivalent number average molecular weight is 10,000,000 or less, and the polystyrene equivalent weight average molecular weight is 1,5000,000 or less, the formability as the sheet tends to be improved. Further, when the polymer is formed into a cast film or the like, the solution viscosity is reduced, and the resulting film or the like tends to be easy to handle. The molecular weight distribution (weight average molecular weight/number average molecular weight) is preferably 1.1 to 5.0, more preferably 1.1 to 4.0, and further preferably 1.1 to 3.5. By adjusting the molecular weight distribution of the norbornene-based polymer within the foregoing ranges, a norbornene-based polymer solution (dope) becomes more likely to be uniform, which facilitates manufacturing of a favorable film.

The norbornene-based polymer of the invention can be obtained by using a monomer of the formula (I), preferably the formula (II) in combination with the following polymerization method.

By using, as a polymerization catalyst, a cation complex of Ni, Pd, Co or the like of Group 8 of the Periodic Table or a cation complex-forming catalyst, such as [Pd(CH₃CN)₄][BF₄]₂, di-μ-chloro-bis(6-methoxybicyclo[2.2.1]hept-2-ene-endo-5σ,2π)-Pd (which is hereinafter simply referred to as “I”) and methylalumoxane (MAO), I and AgBF₄, I and AgSbF₆, [(η3-allyl)PdCl]₂ and AgSbF₆, [(η³-allyl)PdCl]₂ and AgBF₄, [(η³-crotyl)Pd(cyclooctadiene)][PF₆], [(η³-allyl)Pd(η⁵-cyclopentadienyl)]₂ and tricyclohexylphosphine and dimethylanilinium tetrakis pentafluorophenyl borate or trityl tetrakis pentafluorophenyl borate, palladium bisacetylacetonate and tricyclobexylphosphine and dimethylanilinium tetrakis pentafluorophenyl borate, palladium acetate and tricyclohexylphosphine and dimethylanilinium tetrakis pentafluorophenyl borate, [(η³-allyl)PdCl]₂ and tricyclohexylphosphine and tributylallyl tin or allyl magnesium chloride and dimethylanilinium tetrakis pentafluorophenyl borate, [(η⁵-cyclopentadienyl)Ni(methyl)(triphenyl phosphine) and trispentafluorophenyl borane, [(η³-crotyl)Ni(cyclooctadiene)][B((CF₃)₂C₆H₄)₄], [NiBr(NPMe₃)]₄ and MAO, Ni(octoate)₂ and MAO, Ni(octoate)₂ and B(C₆F₅)₃ and AlEt₃, Ni(octoate)₂ and [Ph₃C][B(C₆F₅)₄] and Ali-Bu₃, and Co(neodecanoate) and MAO, the monomers are homo- or co-polymerized in a solvent at a temperature in the range of 20 to 150° C., resulting in the polymer.

There can be adopted both a method in which the monomers are put in a reaction vessel from the start to be allowed to react, and a method in which the monomers are gradually fed.

The solvent can be selected from alicyclic hydrocarbon solvents such as cyclobexane, cyclopentane, and methyl cyclopentane; aliphatic hydrocarbon solvents such as pentane, hexane, heptane, and octane; aromatic hydrocarbon solvents such as toluene, benzene, and xylene; hydrocarbon halide solvents such as dichloromethane, 1,2-dichloroethylene, and chlorobenzene; polar solvents such as ethyl acetate, butyl acetate, γ-butyrolactane, propylene glycol dimethyl ether, and nitromethane.

Alternatively, as other synthesis methods, there are also preferably used the methods described in MACROMOLECULES, 1996, vol. 29, page 2755, MACROMOLECULES, 2002, vol. 35, page 8969, International Publication WO 2004/7564, International Publication WO 2004/50726, International Publication WO 2006/4376, International Publication WO 2006/31067, International Publication WO 2006/13759, and International Publication WO 2006/46611.

### (Norbornene-Based Polymer Film)

The norbornene-based polymer film of the invention denotes a film containing the norbornene-based polymer of the invention therein.

### (Use of Norbornene-Based Polymer Film)

The norbornene-based polymer of the invention is useful as a material for a film. Particularly, the film manufactured using the polymer is suitable for films for optical uses including a substrate of a liquid crystal display device, a light guide plate, a polarizing film, a retardation film, a liquid crystal backlight, a liquid crystal panel, a film for OHP, a transparent electrically conductive film, and the like. Further, the norbornene-based polymer represented by the formula (I) is preferably used for optical materials for an optical disk, an optical fiber, a lens, a prism, and the like, electronic components, further, medical devices, containers, and the like.

### (Manufacturing Method of Norbornene-Based Polymer)

The film of the invention contains the norbornene-based polymer of the invention, and can be manufactured by film formation using the polymer as a raw material. The film formation is accomplished by a method of thermal fusion film formation or a method of solution film formation, and either is applicable. However, in the invention, it is preferable to use a solution casting method capable of providing a film excellent in surface conditions. Below, the solution casting method will be described.

### (Solution Casting Method)

(Preparation of Dope)

First, a solution (dope) of the polymer for use in film formation is prepared. The organic solvents for use in preparation of the dope have no particular restriction so long as the polymer can be dissolved, cast, and formed into a film, thereby to attain the object. Preferred are the solvents selected from, for example, 0 type solvents typified by dichloromethane and chloroform, chain hydrocarbons having 3 to 12 carbon atoms (hexane, octane, isooctane, decane, and the like), cyclic hydrocarbons (cyclopentane, cyclohexane, decalin, and the like), aromatic hydrocarbons (benzene, toluene, xylene, and the like), esters (ethyl formate, propyl formate, pentyl formate, methyl acetate, ethyl acetate, pentyl acetate, and the like), ketones (acetone, methyl ethyl ketone, diethyl ketone, diisobutyl ketone, cyclopentanone, cyclohexanone, methyl cyclohexanone, and the like), and ethers (diisopropyl ether, dimethoxymethane, dimethoxyethane, 1,4dioxane, 1,3-dioxolane, tetrahydrofuran, anisole, phenetole, and the like). Examples of the organic solvent having two or more functional groups may include 2-ethoxy ethyl acetate, 2-methoxy ethanol, and 2-butoxy ethanol. The preferred boiling point of the organic solvent is 35° C. to 200° C. or less. As for the solvents for use in preparation of the solution, two or more solvents can be mixed and used in order to adjust the solution physical properties such as the drying property and the viscosity. Further, so long as the polymer is dissolved in a mixed solvent, a poor solvent can also be added thereto.

Preferred poor solvents can be appropriately selected. When a chlorine type organic solvent is used as a good solvent, alcohols can be preferably used. Alcohols may be preferably linear, branched, or cyclic. Out of these, saturated aliphatic hydrocarbons are preferred. Alcohols may have any of primary to tertiary hydroxyl groups. Further, as alcohols, fluorine type alcohols are also used. Examples thereof may include 2-fluoroethanol, 2,2,2-trifluoroethanol, and 2,2,3,3-tetrafluoro-1-propanol. Out of the poor solvents, particularly, monohydric alcohols have a peel resistance reducing effect, and can be preferably used. Particularly preferred alcohols vary according to the good solvent to be selected. However, in view of the dry load, alcohols having a boiling point of 120° C. or less are preferred, monohydric alcohols having 1 to 6 carbon atoms are further preferred, and alcohols having 1 to 4 carbon atoms can be in particular preferably used.

The particularly preferred mixed solvent for preparing the dope is a combination of dichloromethane as a main solvent, and one or more alcohols selected from methanol, ethanol, propanol, isopropanol, or butanol as poor solvents.

The dope is prepared by the following and other methods: a method by room-temperature stirring dissolution, a cooling dissolution method in which the solution is stirred at room temperature to swell the polymer, and then, is cooled down to −20° C. to −100° C., and is heated again to 20° C. to 10020 C. for dissolution, a high-temperature dissolution method in which the temperature is set at a temperature equal to, or more than the boiling point of the main solvent in a closed container for dissolution, and further a method in which the solution is set at high temperatures and high pressures up to the critical point of the solvent for dissolution. The viscosity of the dope is preferably within the range of 1 to 500 Pa·s, and further preferably within the range of 5 to 200 Pa·s at 25° C.

The solution is preferably subjected to filtration to remove foreign matters such as undissolved matters, dust, and impurities by the use of an appropriate filter of gauze, flannel, or the like prior to casting. Any viscosity immediately before film formation is acceptable so long as it falls within such a range as to allow casting for film formation. The dope is prepared in the range of preferably 5 Pa·s to 1000 Pa·s, more preferably 15 Pa·s to 500 Pa·s, and further preferably 30 Pa·s to 200 Pa·s. Incidentally, the temperature at this step has no particular restriction so long as it is the temperature at the time of casting. However, it is preferably −5 to 70° C., and more preferably −5 to 35° C.

### (Additives)

The film of the invention may contain other additives than the polymer. Such additives may be added at any stage of the steps of manufacturing the film. The additives may be selected according to the uses thereof. Examples thereof may include a deterioration inhibitor, an ultraviolet absorber, a retardation (optical anisotropy) modifier, fine particles, a release accelerator, and an infrared absorber. The additives may be each either a solid or an oily substance. As for the timing of adding the additives, in the case of film manufacturing by a solution casting method, the additives may be added at any timing in the dope preparation process. Alternatively, a step of adding the additives for preparation may be added to the final preparation step in the dope preparation process for carrying out the addition. In the case of film manufacturing by a fusing method, the additives may be added during resin pellets manufacturing, or may be kneaded therein during film manufacturing. The amount of each material to be added has no particular restriction so long as it allows the function to be exerted Whereas, when the film is formed in a multilayered structure, the types and the amounts of additives for respective layers may be different.

From the viewpoint of film deterioration prevention, a deterioration (oxidation) inhibitor is preferably used. For example, phenol type antioxidants such as 2,6-di-tert-butyl, 4-methylphenol, 4,4′-thiobis(6-tert-butyl-3-methylphenol), and pentaerithrityl-tetrakis[3-(3,5-di-tert-butyl-4-hydroxyphenyl)propionate, or hydroquinone type antioxidants may be added. Further, phosphorus type antioxidants such as tris(4-methoxy-3,5-diphenyl)phosphite, tris(nonylphenyl)phosphite, and bis(2,4-di-tert-butylphenyl)pentaerithritol diphosphite are preferably added. The amount of the antioxidant to be added is preferably 0.05 to 5.0 parts by mass per 100 parts by mass of the polymer.

From the viewpoint of deterioration prevention of the polarizing plate, the liquid crystal, or the like, an ultraviolet absorber is preferably used. As the ultraviolet absorber, there is preferably used the ultraviolet absorber which is excellent in absorptive power of an ultraviolet ray with a wavelength of 370 nm or less, and less absorbs a visible light with a wavelength of 400 nm or more from the viewpoint of the good liquid crystal display property. Specific examples of the ultraviolet absorber to be preferably used in the invention may include hindered phenol type compounds, oxybenzophenone type compounds, benzotriazole type compounds, salicylic acid ester type compounds, benzophenone type compounds, cyanoacrylate type compounds, and nickel complex salt type compounds. The amount of the ultraviolet absorber to be added is preferably 1 ppm to 1.0%, and further preferably 10 to 1000 ppm by mass based on the amount of the norbornene-based polymer.

In order to improve the slipping property of the film surface, fine particles (mat agent) is preferably used. By using this, unevenness is given to the film surface, namely, the film surface is increased in surface roughness (matted). This can reduce blocking of the films. The presence of fine particles in the film or on at least one side of the film remarkably improves the adhesion between the polarizer and the film during polarizing plate processing. When the mat agent for use in the invention is formed of inorganic fine particles, the fine particles has an average particle size of, for example, 0.05 μm to 0.5 μm, preferably 0.08 μm to 0.3 μm, and more preferably 0.1 μm to 0.25 μm. The fine particles are preferably silicon dioxide, silicone, and titanium dioxide as inorganic compounds, and fluororesin, nylon, polypropylene, and chlorinated polyether as polymer compounds, more preferably silicon dioxide, and further preferably silicon dioxide which has been surface-treated by an organic matter.

In order to reduce the peel resistance of the film, a release accelerator is preferably used. As preferred release accelerators, phosphoric acid ester type surfactants, carboxylic acid or carboxylic acid salt type surfactants, sulfonic acid or sulfonic acid salt type surfactants, and sulfuric acid ester type surfactants are effective. Alternatively, fluorine type surfactants obtained by replacing a part of the hydrogen atoms attached to the hydrocarbon chain of the surfactant with a fluorine atom is also effective. The amount of the releasing agent to be added is preferably 0.05 to 5 mass %, more preferably 0.1 to 2 mass %, and further preferably 0.1 to 0.5 mass % based on the amount of the norbornene-based polymer.

Various additives are preferably used in order to control the optical performances of the film such as Re, Rth, and wavelength dispersibility. These include low molecular weight compounds having a molecular weight of 1000 or less, oligomer compounds having a molecular weight of about 1000 to 10000, and polymer compounds having a molecular weight of 10000 or more.

### (Film Manufacturing)

As the film manufacturing method and equipment of the invention, there are preferably used the same solution casting film manufacturing method and solution casting film manufacturing apparatus as those made available for manufacturing of conventionally known cellulose triacetate films. The prepared dope from a dissolution apparatus (tank) is once stored in a storage tank. Then, the foams contained in the dope are removed for final preparation.

The cellulose acylate film manufacturing technologies described in each publication of JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511, and JP-A-02-208650 can be preferably adopted in the invention.

### (Multilayer Casting)

The dope may be cast as a monolayer solution on a smooth band or drum as the metal support. Alternatively, two or more layers of a plurality of dopes may be cast. In the case of multilayer casting, the thicknesses of the inner side and the outer side have no particular restriction. However, the thickness of the outside film accounts for preferably 1 to 50%, and more preferably 2 to 30% of the total film thickness.

### (Casting)

The casting methods of the solution include: a method in which the prepared dope is evenly extruded from a pressing die onto the metal support; a method by a doctor blade in which the dope once cast on the metal support is controlled by a blade in film thickness; a method by a reverse roll coater in which control is carried out by means of a counterrotating roll, or other methods. However, the method by means of a pressing die is preferred. The temperature of the dope to be used for casting is preferably −10 to 55° C., and more preferably 25 to 50° C. In that case, the temperature maybe the same throughout all the steps, or the steps may vary at respective portions of the step. When the temperature varies, a desired temperature is preferably achieved immediately before casting.

### (Drying)

Drying of the dope on the metal support in manufacturing of the film is generally accomplished by the following methods: a method in which a hot air is applied from the surface side of the metal support (e.g., drum or belt), i.e., from the surface of the web on the metal support; a method in which a hot air is applied from the rear side of the drum or the belt; a liquid heat transfer method in which a temperature-controlled liquid is brought in contact with the rear side of the belt or the drum, which is the opposite side from the dope cast side, thereby to heat the drum or the belt by heat transfer for controlling the surface temperature; and other methods. Of these, the rear side liquid heat transfer method is preferred The surface temperature of the metal support prior to casting may be any temperature so long as it is equal to, or less than the boiling point of the solvent used in the dope. However, in order to promote drying, or in order to eliminate the fluidity on the metal support, the temperature is preferably set at a temperature lower by 1 to 10° C. than the boiling point of the solvent having the lowest boiling point out of the solvents used. Incidentally, this does not apply to the case where the cast dope is released off without cooling nor drying.

### (Peeling)

When a half-dried film is peeled from the metal support, and the peel resistance (peel load) is large, the film is irregularly stretched in a direction of film formation, thereby to cause optically anisotropic unevenness. Particularly, in the case where the peel load is large, portions stepwise stretched in the direction of film formation and portions not stretched are alternately formed to cause a distribution in retardation. Thus, when the film is mounted on a liquid crystal display device, striated or band-like unevenness becomes observable.

The peel load of the film can be calculated before manufacturing of the film in a simple manner by the following test. Namely, the manufactured dope is formed into a film by casting by means of an applicator. After an elapse of a given time (peel start time), the solvent is evaporated to form a film on a SUS plate. Then, the load when a web with a given width is vertically peeled from the SUS plate at a given speed is measured with a load cell. The maximum peel load obtained is determined, and is expressed in terms of the peel load (gf/cm), and the value is compared.

When the same polymer material is used, the methods for reducing the peel load include a method of adding a release agent as mentioned above and a method by selection of a solvent composition to be used. A preferred volatile content concentration during peeling is 5 to 60 mass %, further preferably 10 to 50 mass/, and in particular preferably 20 to 40 mass %. Peeling with a high volatile content is preferred because a rapid drying speed can be achieved, resulting in improved productivity. On the other band, with the high volatile content, the strength and elasticity of the film are small, and hence the film tends to be cut or stretched because the film does not withstand the peel force. Further, the self-holding power after peeling is poor and hence deformation, wrinkle, and cracks become more likely to occur. Further, these cause the distribution in retardation.

### (Stretching)

When the film manufactured with the solution casting method is further subjected to a stretching treatment, the stretching treatment is preferably carried out with the solvent sufficiently still remaining in the film immediately after peeling. Stretching is carried out for the purposes of (1) obtaining a film free from wrinkles and deformation, and excellent in flatness; and (2) increasing the in-plane retardation of the film. When stretching is carried out for the purpose (1), stretching is carried out at a relatively high temperature, and stretching at a stretch ratio as low as from I % up to 10% at most is carried out. 2% to 5% stretching is particularly preferred. When stretching is carried out for both the purposes (1) and (2), or for only the purpose (2), stretching is carried out at a relatively low temperature and also at a stretch ratio of 5 to 150%.

Stretching of the film may be only longitudinal or transverse monoaxial stretching, or may be simultaneous or sequential biaxial stretching. As for the birefringence of the retardation film for a VA liquid crystal cell or an OCB (Optically Compensatory Bend) liquid crystal cell, the refractive index in the direction of width is preferably larger than the refractive index in the direction of length. Therefore, the film is preferably more stretched in the direction of width.

The thickness of the completed (dried) film of the invention varies according to the intended use. However, it is generally within the range of 20 to 500 μm, preferably within the range of 30 to 150 μm, and in particular preferably 40 to 110 μm for a liquid crystal display device.

### (Characteristics of Film)

The preferred optical characteristics of the film of the invention varies according to the use of the film. Below, the preferred ranges in respective uses of the in-plane retardation (Re) and the retardation in the direction of thickness (Rth) converted with the thickness of the film as 80 μm will be shown. Incidentally, each value represents the value for the measurement at a wavelength of 590 nm.

When the film is used as a polarizing plate protective film: Re is preferably 0 nm≦Re≦5 nm, and further preferably 0 nm≦Re≧3 nm. Rth is preferably 0 nm≦Rth≦50 nm, further preferably 0 nm≦Rth≦35 nm, and in particular preferably 0 nm≦Rth≦10 nm.

When the film is used as a retardation film: the ranges of Re and Rth vary according to the kind of the retardation film. There are various needs. However, it is preferable that, 0 nm≦Re≦100 nm, and 0 nm≦Rth≦40 nm. For the TN mode, more preferably, 0 nm≦Re≦20 nm, and 40 nm≦Rth≦80 nm; and for the VA mode, 20 nm≦Re≦80 nm, and 80 nm≦Rth≦400 nm. Particularly, the preferred ranges for the VA mode are: 30 nm≦Re≦75 nm, and 120 nm≦Rth≦250 nm. When compensation is done by one sheet of retardation film, 50 nm<Re<75 nm and 180 nm<Rth≦250 nm. When compensation is done by two sheets of retardation films, 30 nm<Re<50 nm, and 80 nm<Rth<140 nm. These are preferred embodiments for the compensation film of a VA mode in view of color shift upon black display and of visual angle dependency of contrast. The film of the invention is particularly preferably used as a retardation film of a VA mode. For this reason, Re of the film of the inventions is: preferably 20 nm≦Re≦200 nm, and further preferably 20 nm≦Re≦80 nm.

The film of the invention can achieve desired optical characteristics by appropriately adjusting step conditions such as copolymerization ratio, type and amount to be added of additives, stretching ratio, and residual volatile content upon peeling.

In this specification, Re(λ) and Rth(λ) represent the in-plane retardation and the retardation in the direction of thickness at a wavelength λ, respectively. Re(λ) is measured by making light with a wavelength of λ nm incident in the direction of normal to the film by means of KOBRA 21ADH or WR (manufactured by Oji Scientific Instruments Co., Ltd.). For selection of the measurement wavelength of λ nm, measurement can be performed by manually exchanging the wavelength selection filter, or converting the measured values by a program or the like.

When the film to be measured is expressed as a monoaxial or biaxial refractive index ellipsoid, Rth(λ) is calculated in the following manner.

Rth(λ) is calculated by means of KOBRA 21ADH or WR based on the retardation values measured, the hypothetical value of the average refractive index, and the inputted film thickness value. The retardation values are measured at a total of 6 points for light having a wavelength of λ nm made incident from the direction tilted to one side in steps of 10 degrees up to 50 degrees from the normal direction with respect to the film normal direction with the in-plane slow axis (judged by KOBRA 21ADH or WR) as a tilt axis (rotational axis), (a given film in-plane direction being regarded as the rotational axis when there is no slow axis).

In the above, in the case of a film having a direction where a retardation value becomes zero at a certain tilt angle from the normal line direction with the in-plane slow axis as the rotational axis, the retardation value at a tilt angle larger than the tilt angle is calculated by means of KOBRA 21ADH or WR after changing the sign to negative.

Incidentally, retardation values are measured from given two tilted directions with the slow axis as a tilt axis (rotational axis), (a given film in-plane direction being regarded as the rotational axis when there is no slow axis). Thus, it is also possible to calculate Rth according to the following expressions (1) and (2) based on the retardation values measured, the hypothetical value of the average refractive index, and the inputted film thickness value

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Expression ( 1 )$$

Note: The Re(θ) represents a retardation value in a direction tilted at an angle θ from the normal line direction. d represents the film thickness.

nx in the mathematical expression (1) represents the refractive index in the slow axis direction in the plane, ny represents the refractive index in a direction orthogonal to that of nx in the plane, and nz represents the refractive index in a direction orthogonal to those of nx and ny.

Rth=((nx+ny))/2−nz)xd Expression (2)

When the film to be measured cannot be expressed by a monoaxial or biaxial refractive index ellipsoid, i.e., is a so-called film having no optic axis, Rth(λ) is calculated in the following manner.

Rth(λ) is calculated by means of KOBRA 21ADH or WR based on the retardation values measured, the hypothetical value of the average refractive index, and the inputted film thickness value. The retardation values are measured at 11 points in the following manner: Re(λ) is measured for light having a wavelength of λ nm made incident from the direction tilted in steps of 10 degrees from −50 degrees up to 50 degrees with respect to the film normal direction with the in-plane slow axis (judged by KOBRA 21ADH or WR) as a tilt axis (rotational axis).

In the measurement, as the hypothetical values of the average refractive index, the values in POLYMER HANDBOOK, (JOHN WILEY & SONS, INC) and catalogues of various optical films can be used. When the values of the average refractive index are not known, they can be measured by means of an Abbe refractormeter. The values of the average refractive indices of main optical films will be exemplified below: cellulose acylate (1.48), cycloolefin polymer (1.52), polycarbonate (1.59), polymethyl methacrylate (1.49), and polystyrene (1.59). By inputting these hypothetical values of the average refractive index and film thickness, nx, ny, and nz are calculated by means of KOBRA 21ADH or WR. Nz=(nx−nz)/(nx−ny) is further calculated from the calculated nx, ny, and nz.

Further, when the film of the invention is used as a protective film for a polarizing plate, preferably, the value of photoelasticity is 0.5×10⁻¹³ to 9.0×10⁻¹³ [cm²/dyn], and the value of moisture permeability (however, the value converted with the thickness of the film as 80 μm) is 180 to 435 [g/cm²24 h]. The value of photoelasticity is preferably 0.5×10⁻¹³ to 7.0×10⁻¹³ [cm²/dyn], and further preferably 0.5×10⁻¹³ to 5.0×10⁻¹³ [cm²/dyn]. Whereas, the value of moisture permeability (however, the value converted with the thickness of the film as 80 μm) is more preferably 180 to 400 [g/cm²24 h], and further preferably 180 to 350 (g/cm²24 h). The film of the invention having the foregoing characteristics can reduce the degradation of the performances due to the effects of the humidity when used as the protective film for a polarizing plate.

### (Polarizing Plate)

The polarizing plate of the invention has at least the film of the invention and a polarizer. Generally, the polarizing plate has a polarizer and two protective films placed on opposite sides thereof. The film of the invention can be used as both or one of the protective films. A general cellulose acetate film, or the like may be used for another protective film. Polarizers include iodine type polarizer, dye type polarizer using a dichromatic dye, and polyene type polarizer. The iodine type polarizer and dye type polarizer are generally manufactured using a polyvinyl alcohol type film. When the film of the invention is used as a protective film for a polarizer, the film is subjected to a surface treatment as described later, and then, the film treated surface and a polarizer are bonded using an adhesive. Examples of the adhesive to be used may include polyvinyl alcohol type adhesives such as polyvinyl alcohol and polyvinyl butyral, a vinyl type latex such as butyl acrylate, and gelatin. The polarizing plate is formed of a polarizer and protective films for protecting the opposite sides thereof. Further, one side of the polarizing plate is bonded with a protective film, and another side is bonded with a separate film. The protective film and the separate film are used for the purpose of protecting the polarizing plate during shipping, product inspection, and the like of the polarizing plate. In this case, the protective film is bonded for the purpose of protecting the surface of the polarizing plate, and is used for the opposite surface side from the surface to be bonded to the liquid crystal plate. Whereas, the separate film is used for the purpose of covering the adhesion layer to be bonded to the liquid crystal plate, and is used on the side of the surface for bonding the polarizing plate to the liquid crystal plate. As for the manner in which the film of the invention is bonded to the polarizer, bonding is preferably carried out so that the transmission axis of the polarizer and the slow axis of the film are in alignment with each other.

### (Surface Treatment of Film)

In the invention, the film is preferably subjected to a surface treatment in order to improve the adhesion between the polarizer and the protective film. With regard to the surface treatment, any methods may be utilized so long as they can improve the adhesion. Examples of preferred surface treatments may include a glow discharge treatment, an ultraviolet irradiation treatment, a corona treatment, and a flame treatment. The glow discharge treatment herein referred to is so-called low temperature plasma caused under a low-pressure gas. In the invention, a plasma treatment under an atmospheric pressure is also preferred. In addition, the details of the glow discharge treatment are described in U.S. Pat. Nos. 3,462,335, 3,761,299, 4,072,769,and English Patent No. 891469. The method described in JP-T-59-556430 (the term “JP-T” used herein means a published Japanese translation of a PCT patent application) is also used, wherein a discharge atmospheric gas composition consists solely of a gas species generated in a vessel by subjecting a polyester support itself to a discharge treatment after the start of discharge. Further, the method described in JP-B-60-16614 is also applicable, wherein the discharge treatment is conducted while setting the surface temperature of the film at 80° C. to 180° C. during the vacuum glow discharge treatment.

With regard to the degree of the surface treatment, the preferred range varies depending on the kind of the surface treatment. However, it is preferable that the surface treatment thereof results in a contact angle between the surface of the protective film subjected to the surface treatment and pure water of less than 50°. The contact angle is more preferably 25° or more to less than 45°. When the contact angle between the surface of the protective film and pure water falls within the foregoing range, the adhesion strength between the protective film and the polarizing film becomes favorable.

### (Adhesive)

For bonding of the polarizer formed of polyvinyl alcohol to the film of the invention subjected to the surface treatment, it is preferable to use an adhesive containing a water-soluble polymer. The water-soluble polymers to be preferably used for the adhesive may include homopolymers or polymers having ethylenically unsaturated monomers as compositional elements, such as N-vinyl pyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetone acrylamide, and vinyl imidazole; or polyoxyethylene, polyoxypropylene, poly-2-methyloxazoline, methyl cellulose, hydroxyethyl cellulose, hydroxypropyl cellulose gelatin, and the like. In the invention, out of these, PVA and gelatin are preferred. The thickness of the adhesive layer is preferably 0.01 to 5 μm, and more preferably 0.05 to 3 μm after drying.

### (Antireflection Layer)

The protective film disposed on the opposite side of the polarizing plate from the liquid crystal cell is preferably provided with a functional film such as an antireflection layer. Particularly, in the invention, there is preferably used an antireflection layer configured such that at least a light scattering layer and a low refractive index layer are stacked in this order on the protective film, or an antireflection layer configured such that an intermediate refractive index layer, a high refractive index layer, and a low refractive index layer are stacked in this order on the protective film.

### (Light Scattering Layer)

The light scattering layer is formed for the purpose of imparting, to the film, light diffusibility due to surface scattering and/or internal scattering, and a hard coat property for improving the scratch resistance of the film. Therefore, the layer is formed to include a binder for imparting the hard coat property, mat particles for imparting the light diffusibility, and if required, inorganic fillers for achieving higher refractive index, prevention of crosslinking and shrinkage, and higher strength. The film thickness of the light scattering layer is preferably 1 to 10 μm, more preferably 1.2 to 6 μm from the viewpoint of imparting the hard coat property and from the viewpoint of suppressing occurrence of curling and deterioration of brittleness.

### (Other Layers of Antireflection Film)

Further, a hard coat layer, a front scattering layer, a primer layer, an antistatic layer, an undercoat layer, a protective layer, or the like may be provided.

### (Hard Coat Layer)

The hard coat layer is provided on the surface of the support in order to impart physical strength to the protective film provided with the antireflection layer. Particularly, it is preferably provided between the support and the high refractive index layer. The hard coat layer is preferably formed by a crosslinking reaction of a light and/or heat curable compound or a polymerization reaction. The curable functional group is preferably a photopolymerizable functional group. Further, a hydrolyzable functional group-containing organometallic compound is preferably an organic alkoxysilyl compound.

### (Antistatic Layer)

When an antistatic layer is provided, an electric conductivity of a volume resistivity of 10⁻⁸ (Ωcm⁻³) or less is preferably imparted thereto. The volume resistivity of 10⁻⁸ (Ωcm⁻³) can be imparted by the use of a hygroscopic substance, a water soluble inorganic salt, a certain kind of surfactant, a cation polymer, an anion polymer, colloidal silica, or the like. However, unfavorably, the temperature and humidity dependency is large, so that a sufficient electric conductivity cannot be ensured at low humidity. For this reason, a metal oxide is preferred as the conductive layer material.

### (Liquid Crystal Display Device)

The film of the invention, the retardation film including the film, and the polarizing plate using the film can be employed for liquid crystal cells of various display modes and liquid crystal display devices. Various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), and HAN (Hybrid Aligned Nematic) modes have been proposed. Out of these, they can be preferably used for the OCB mode or the VA mode.

### EXAMPLES

Below, the invention will be further specifically described by way of Examples. The materials, amounts, ratios, contents of treatments, procedures of the treatments, and the like shown in the following Examples can be appropriately changed so long as they deviate from the gist of the invention. Therefore, the scope of the invention is not limited to the following specific Examples.

### (Norbornene-Based Compound)

Among norbornene compounds of the raw materials for the norbornene polymer for use in the invention, norbornene carboxylic acid methyl ester (NBCOOCH₃) is available from TOKYO CHEMICAL INDUSTRY, Co., Ltd. The compound was subjected to gas chromatography, and was measured for the peak purity. As a result, NBOCOCH₃ was found to have a purity of 99.0%, and an endo/exo ratio of 78/22. Other norbornene-based compounds were manufactured as in the following Synthesis Examples.

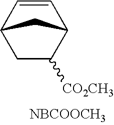

### Synthesis Example 1

### Synthesis of 5-acetoxymethyl-2-norbornene (NBCH₂OCOCH₃ (83/17))

1094 g of dicyclopentadiene (manufactured by Wako Pure Chemical Industries, Ltd), 1772 g of allyl acetate (manufactured by Wako Pure Chemical Industries, Ltd), and 1 g of hydroquinone (manufactured by Wako Pure Chemical Industries, Ltd) were charged into an autoclave, and the space was replaced with nitrogen. Stirring was carried out in a closed system at an internal temperature of 180° C. for 9 hours (rotation speed=300 rpm). The reaction mixture was filtrated, and the volatile components were subjected to evaporation. The residual matters were subjected to precision distillation (column length=120 cm, column packing=Propak, reflux ratio=10/1, pressure=10 mmHg, top temperature=89° C.), resulting in colorless and transparent NBCH₂OCOCH₃. The resulting product was subjected to gas chromatography, and was measured for the peak purity. As a result, it was found to have a purity of 99.9% and an endo/exo ratio of 83/17.

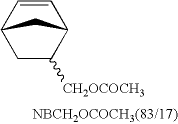

### Synthesis Example 2

### Synthesis of 5-acetoxymethyl-2-norbornene (NBCH₂OCOCH₃ (59/41)

572 g of dicyclopentadiene (manufactured by Wako Pure Chemical Industries, Ltd), 1309 g of allyl acetate (manufactured by Wako Pure Chemical Industries, Ltd), and 1 g of hydroquinone (manufactured by Wako Pure Chemical Industries, Ltd) were charged into an autoclave, and the space was replaced with nitrogen. Stirring was carried out in a closed system at an internal temperature of 270° C. for 3 hours (rotation speed=300 rpm). The reaction mixture was filtrated, and the volatile components were subjected to evaporation. The residual matters were subjected to simple distillation, resulting in colorless and transparent NBCH₂OCOCH₃. The resulting product was subjected to gas chromatography, and was measured for the peak purity. As a result, it was found to have a purity of 98.7% and an endo/exo ratio of 59/41.

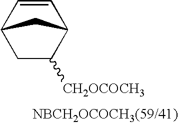

### Synthesis Example 3

### Synthesis of 5-hexyloxymethyl-2-norbornene (NBCH₂OCOC₅H₁₁)

The same procedure was carried out as in Synthesis Example 1, except that allyl acetate was changed to allyl hexanoate (manufactured by Wako Pure Chemical Industries, Ltd) in synthesis Example 1. As a result, colorless and transparent NBCH₂OCOC₅H₁₁ was obtained. The resulting product was subjected to gas chromatography, and was measured for the peak purity. As a result, it was found to have a purity of 99.0% and an endo/exo ratio of 79/21.

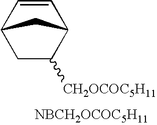

### Synthesis Example 4

### Synthesis of endorich-phenyl norbornene (endorich-PhNB)

674.0 g of dicyclopentadiene (manufactured by Wako Pure Chemical Industries, Ltd), 508.0 g of styrene (manufactured by Wako Pure Chemical Industries, Ltd), and 1 g of hydroquinone (manufactured by Wako Pure Chemical Industries, Ltd) were charged into an autoclave, and the space was replaced with nitrogen. Stirring was carried out in a closed system at an internal temperature of 180° C. for 8 hours (rotation speed=300 rpm). The reaction mixture was subjected to flash distillation, and residual cyclopentadiene, styrene, and polymerization product were removed, resulting in crude PHNB. This was subjected to precision distillation, resulting in colorless and transparent endorich-PhNB. The resulting colorless and transparent liquid was subjected to gas chromatography, and was measured for the peak purity. As a result, it was found to have a purity of 98.5% and an endo/exo ratio of 78/22.

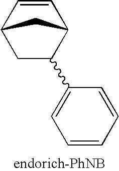

### Synthesis Example 5

### Synthesis of exo-phenyl norbornene (exo-PhNB)

100.0 g of iodobenzene (manufactured by Wako Pure Chemical Industries, Ltd), 200 mL of norbornadiene (manufactured by TOKYO CHEMICAL INDUSTRY, Co., Ltd.), 200 mL of dimethylformamide, 225 mL of triethylamine (manufactured by Wako Pure Chemical Industries, Ltd), 48 mL of formic acid (purity 99%, manufactured by Wako Pure Chemical Industries, Ltd.), and 3.4 g of palladium dichlorobis triphenylphosphine (manufactured by TOKYO CHEMICAL INDUSTRY, Co., Ltd.) were charged, and were allowed to react at an internal temperature of 50° C. for 3 hours. This was subjected to separating extraction with ethyl acetate/water, to take out the organic layer. The organic layer was dried with magnesium sulfate, and was filtrated, and the volatile components were evaporated. The residue was subjected to column chromatography, and was distilled with hexane. The residue obtained by concentration was subjected to reduced pressure distillation (3 mmHg/95° C.), resulting in colorless and transparent exo-PhNB. The resulting colorless and transparent liquid was subjected to gas chromatography, and was measured for the peak purity. As a result, it was found to have a purity of 98.0% and an endo/exo ratio of 0/100.

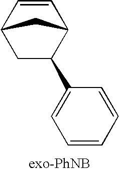

### Synthesis Example 6

### Synthesis of exo-1-naphthyl norbornene (exo-NBNaph)

123.0 g of 1-iodonaphthalene (manufactured by Aldrich Co.), 200 mL of dimethylformamide (manufactured by Wako Pure Chemical Industries, Ltd.), 170 mL of norbornadiene (manufactured by TOKYO CHEMICAL INDUSTRY, Co., Ltd.), 270 mL of triethylamine (manufactured by Wako Pure Chemical Industries, Ltd), 58 mL of formic acid (purity 99%, manufactured by Wako Pure Chemical Industries, Ltd.), and 5.16 g of palladium dichloro bis triphenylphosphine (manufactured by TOKYO CHEMICAL INDUSTRY, Co., Ltd.) were charged, and were stirred at 60° C. for 3 hours. The reaction solution was extracted with ethyl acetate/water, and the organic layer was dried with magnesium sulfate. This was filtrated, and evaporated. The residue was subjected to column chromatography (developing solvent: hexane), and the resulting solution was evaporated. This was subjected to reduced pressure distillation (3 mmHg/150 to 155° C.). The resulting colorless and transparent liquid (exo-NBNaph) was subjected to gas chromatography, and was measured for the peak purity. As a result, it was found to have a purity of 99.0% and an endo/exo ratio of 0/100.

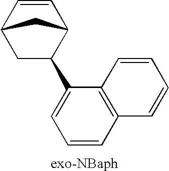

### Synthesis of Norbornene-Based Polymer

### Example 1

### Synthesis of P-1

332.1 g of NBCH₂OCOCH₃ (59/41) and 1.60 g of endorich-PhNB were charged into a reaction vessel. Then, a solution obtained by allowing 85.5 mg of palladium bis acetylacetonate (manufactured by TOKYO CHEMICAL INDUSTRY, Co., Ltd.), and 88.5 mg of tricyclohexylphosphine (manufactured by Strem Co.) to react with 10 mL of toluene was added thereto. Subsequently, 454 mg of dimethylanilinium/tetrakis pentafluorophenyl borate (manufactured by Strem Co.) dissolved in 5 mL of methylene chloride was added thereto. Further, 1325 mL of toluene was added thereto. The solution was stirred at 95° C. for 6 hours. 2.8 L of toluene was added thereto, and 10 L of methanol was added thereto dropwise with stirring over 3 hours. The resulting precipitate was filtrated. This was washed in methanol, and was subjected to suction filtration again. Vacuum drying was carried out at 120° C. for 6 hours. 314 g of P-1 of a white solid was obtained.

The P-1 was dissolved in deuterated dichloromethane, and the ¹HNMR thereof was measured. From the comparison between the integral value of the peak (methylene hydrogen bound to an acetoxy group) occurring at 3.3 to 4.7 ppm and the integral value of the peak (a hydrogen of a phenyl group) occurring at 7.2 ppm, the copolymerization ratio was 0.5/99.5.

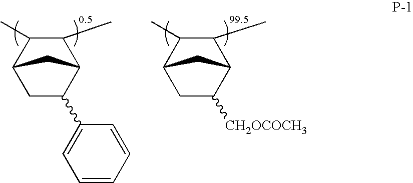

The obtained polymer was dissolved in tetrahydrofuran, and the molecular weight thereof was measured by the gel permeation chromatography (GPC). The polystyrene equivalent weight average molecular weight (Mw) was found to be 292500, and the polystyrene equivalent number average molecular weight (Mn) was found to be 112700.

### Examples 2 to 4

### Synthesis of P-2, P-3, and P4

P-2, P-3, and P-4 were synthesized by the same operation as in Example 1, except that the amounts of endorich-PhNB to be added were set at 0.16 g, 3.20 g, and 4.80 g, respectively. The copolymerization ratios were determined in the same manner as in Example 1, and were found to be 0.05/99.95, 1.0/99.0, and 1.5/98.5, respectively. The molecular weights thereof are summarized in Table 1.

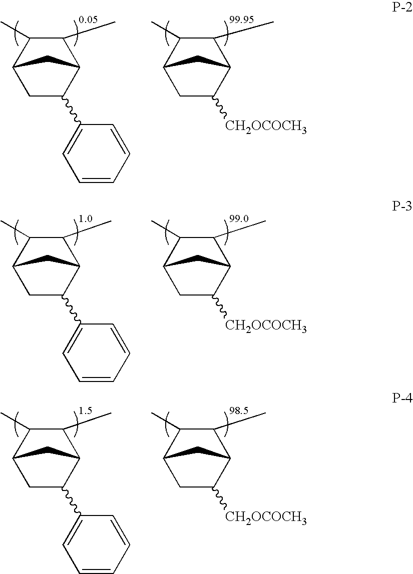

### Example 5

### Synthesis of P-5

P-5 was synthesized in the same manner as in Example 1, except that exo-PhNB was used in place of endorich-PhNB. The copolymerization ratio was determined in the same manner as in Example 1, and was found to be 0.5/99.5. The molecular weight thereof is shown in Table 1.

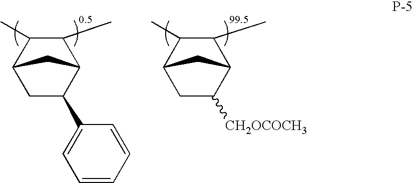

### Example 6

### Synthesis of P-6

P-6 was synthesized in the same manner as in Example 1, except that an equimolar amount of exo-NBNaPh was used in place of endorich-PhNB. The copolymerization ratio was determined from the peak (methylene hydrogen bound to an acetoxy group) occurring at 3.3 to 4.7 ppm and the peak in the aromatic region in the same manner as in Example 1, and was found to be 0.5/99.5. The molecular weight thereof is shown in Table 1.

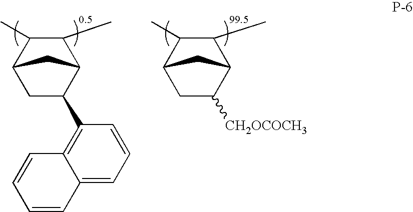

### Example 7

### Synthesis of P-7

P-7 was synthesized in the same manner as in Example 1, except that NBCH₂OCOCH₃ (83/17) was used in place of NBCH₂OCOCH₃ (59/41). The copolymerization ratio was determined in the same manner as in Example 1, and was found to be 0.5/99.5. The molecular weight thereof is shown in Table 1.

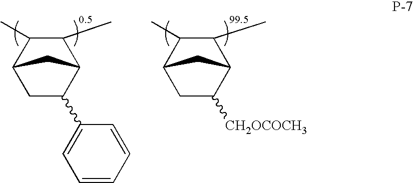

### Example 8

### Synthesis of P-8

P-8 was synthesized by the same operation as in Example 1, except that NBCH₂OCOC₅H₁₁ was used in place of NBCH₂OCOCH₃ (59/41). The copolymerization ratio was determined in the same manner as in Example 1, and was found to be 0.5/99.5. The molecular weight thereof is shown in Table 1.

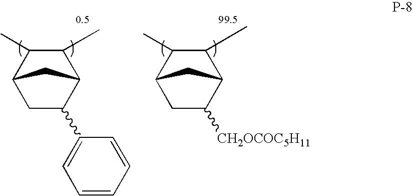

### Example 9

### Synthesis of P-9

304.4 g of NBCOOCH₃ and 0.32 g of endorich-PhNB were charged into a reaction vessel. Then, a solution obtained by allowing 85.5 mg of palladium his acetylacetonate (manufactured by TOKYO CHEMICAL INDUSTRY, Co., Ltd.), and 88.5 mg of tricyclohexylphosphine (manufactured by Strem Co.) to react with 10 mL of toluene was added thereto. Subsequently, 454 mg of dimethylanilinium/tetrakis pentafluorophenyl borate (manufactured by Strem Co.) dissolved in 5 mL of methylene chloride was added thereto. The solution was stirred at 95° C. for 6 hours. The viscosity of the contents increased as the reaction proceeded, and accordingly, toluene was appropriately added thereto. Toluene was added thereto in an amount of 2.0 L, and 10 L of methanol was added thereto dropwise with stirring over 3 hours. The resulting precipitate was filtrated. This was washed in methanol, and was subjected to suction filtration again. Vacuum drying was carried out at 120° C. for 6 hours. 213 g of P-9 of a white solid was obtained.

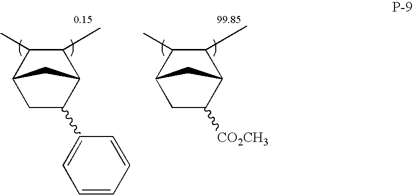

The P-9 was dissolved in deuterated dichloromethane, and the ¹HNMR thereof was measured. From the comparison between the integral value of the peak. (methyl ester hydrogen) occurring at 3.45 to 4.2 ppm and the integral value of the peak. (a hydrogen of a phenyl group) occurring at 7.2 ppm, the copolymerization ratio was 0.15/99.85.

### Example 10

### Synthesis of P-10

100.0 g of the P-1 obtained in Example 1 was added into a solution of 910 g of methylene chloride, 108 g of methanol, and 1.0 g of 20% methanol solution of sodium methoxide (manufactured by Wako Pure Chemical Industries, Ltd.), and stirred at 150 rpm for 30 minutes. 10 mL of acetic acid was added thereto dropwise, and this was reprecipitated in 10 L of methanol. The resulting precipitate was filtrated. This was washed in methanol, and was subjected to suction filtration again. Vacuum drying was carried out at 120° C. for 6 hours. 99.0 g of P-10 of a white solid was obtained. Out of this, 0.3 g of the resulting product was dissolved in 15 mL of methylene chloride. 3 mL of pyridine (manufactured by Wako Pure Chemical Industries, Ltd.) and 4 mL of benzoyl chloride (manufactured by Wako Pure Chemical Industries, Ltd.) were added, and stirred at room temperature for 1 hour. This was reprecipitated in methanol, resulting in a polymer P-10′ whose OH moiety has been benzoylated. This was vacuum dried as with Example 1. The dried product was dissolved in deuterated dichloromethane, and the ¹HNMR thereof was measured. From the comparison between the integral value of the peak (methylene hydrogen bound to an acetoxy group) occurring at 3.3 to 4.7 ppm and the integral value of the peak (hydrogen of a benzoyl group and a phenyl group) occurring in the aromatic region, the copolymerization ratio was 86.0/14.0. The phenyl group derived from P-1 has not reacted and has remained. Therefore, the copolymerization ratio of P-10 was calculated to be 0.5/85.5/14.0. The molecular weight is shown in Table 1.

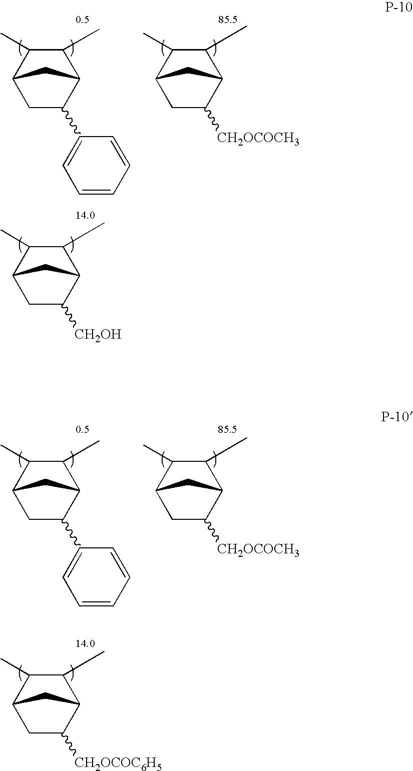

### Example 11

### Synthesis of P-11

166.1 g of NBCH₂OCOCH₃ (59/41), 152.2 g of NBCOOCH₃, and 3.2 g of endorich-PhNB were charged into a reaction vessel. The same operation was carried out as in Example 3, thereby to synthesize P-11.

The P-11 was dissolved in deuterated dichloromethane, and the ¹³CNMR thereof was measured. From the comparison of the integral value of the peak of an acetyl group occurring at 172 ppm and of the peak of a methyl ester group occurring at 175 ppm, the ratio of an acetyl group and a methyl ester group was calculated to 60/40. Further, ¹HNMR thereof was measured, and from the comparison between the integral value of the total of peaks of the methylene hydrogen of an acetyl group and the methyl hydrogen of a methyl ester group occurring in an overlapping relation at 3.3 to 4.7 ppm and the integral value of the peak (hydrogen of a phenyl group) occurring at 7.2 ppm, the copolymerization ratio was calculated to be 59.4/39.6/1.0. The molecular weight is shown in Table 1.

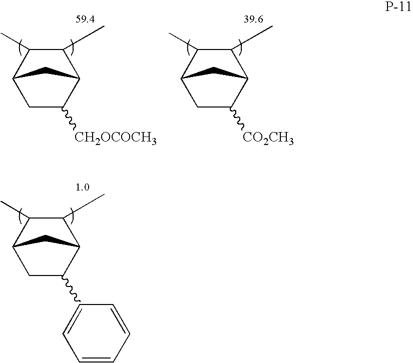

### Example 12

### Synthesis of P-12

P-12 was synthesized by the same operation as in Example 1, except that the amount of endorich-PhNB to be added was set at 0.03 g. As with Example 1, the copolymerization ratio was determined. As a result, the peak of a phenyl group was minute, and thus was undetectable. On the other hand, the filtrate of reprecipitation was analyzed by gas chromatography, and no endorich-PhNB was detected. Accordingly, endorich-PhNB was found to be fully incorporated in the formed P-12. In view of the result and the yield, the copolymerization ratio was found to be 0.01/99.99. The molecular weight is shown in Table 1.

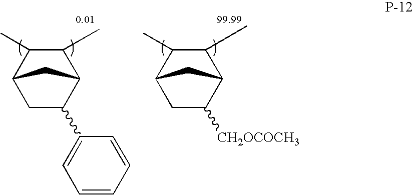

### Example 13

### Synthesis of P-13

P-13 was synthesized by the same operation as in Example 1, except that the amount of endorich-PhNB to be added was set at 6.40 g. As with Example 1, the copolymerization ratio was determined, and was found to be 2.0/98.0. The molecular weight is shown in Table 1.

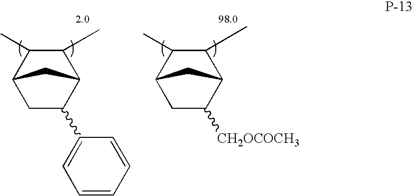

### Comparative Example 1

### Synthesis of PC-1

PC-1 was synthesized by the same operation as in Example 1, except that endorich-PhNB was not added, and only NBCH₂OCOCH₃ (59/41) was used as a monomer. The molecular weight is shown in Table 1.

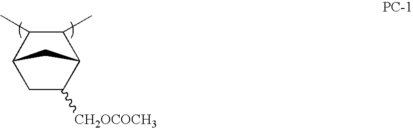

### Comparative Example 2

### Synthesis of PC-2

PC-2 was synthesized by the same operation as in Example 7, except that endorich-PhNB was not added, and only NBCH₂OCOCH₃ (83/17) was used as a monomer. The molecular weight is shown in Table 1.

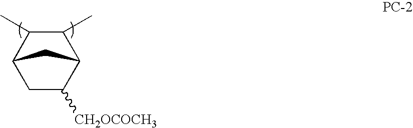

### Comparative Example 3

### Synthesis of PC-3

PC-3 was synthesized by the same operation as in Example 8, except that endorich-PhNB was not added, and only NBCH₂OCOC₅H₁₁ was used as a monomer. The molecular weight is shown in Table 1.

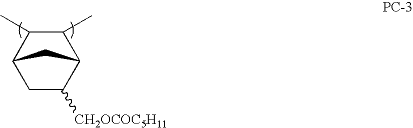

### Comparative Example 4

### Synthesis of PC-4

PC4 was synthesized by the same operation as in Example 9, except that endorich-PhNB was not added, and only NBCOOCH₃ was used as a monomer. The molecular weight is shown in Table 1.

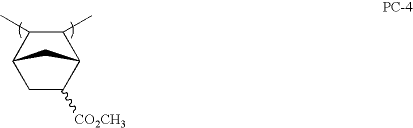

### Comparative Example 5

### Synthesis of PC-5

PC-5 was synthesized by methanolysis of PC-1 as with Example 10. The molecular weight is shown in Table 1.

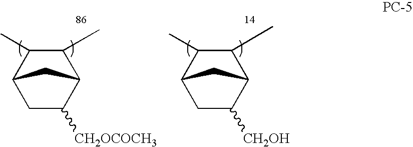

### Comparative Example 6

### Synthesis of PC-6

PC-6 was synthesized by the same operation as in Example 11, except that endorich-PhNB was not added, and only NBCH₂OCOCH₃ (59/41) and NBCOOCH₃ were used as monomers (equivalent amounts as in Example 11). As with Example 11, the ¹³CNMR was measured, and the copolymerization ratio was calculated to be 60/40. The molecular weight is shown in Table 1.

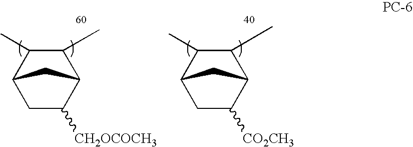

### Comparative Example 7

### Synthesis of PC-7

PC-7 was synthesized by the same operation as in Example 1, except that the amount of endorich-PhNB to be added was set at 16.0 g. The copolymerization ratio was found to be 5.9/94.1. The molecular weight is shown in Table 1.

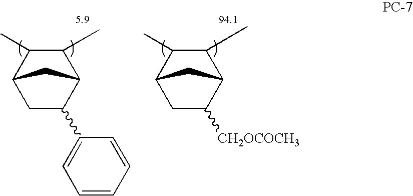

TABLE 1

| | | Mw | Mn | Mw/Mn |
|---|---|---|---|---|
| Example 1 | P-1 | 292500 | 112700 | 2.60 |
| Example 2 | P-2 | 301000 | 124000 | 2.43 |
| Example 3 | P-3 | 298300 | 113400 | 2.63 |
| Example 4 | P-4 | 299000 | 113200 | 2.64 |
| Example 5 | P-5 | 312000 | 123400 | 2.53 |
| Example 6 | P-6 | 324000 | 113500 | 2.85 |
| Comparative Example 1 | PC-1 | 293400 | 112000 | 2.62 |
| Comparative Example 7 | PC-7 | 352300 | 143200 | 2.46 |
| Example 7 | P-7 | 348500 | 102300 | 3.41 |
| Comparative Example 2 | PC-2 | 345000 | 103400 | 3.34 |
| Example 8 | P-8 | 304500 | 94300 | 3.23 |
| Comparative Example 3 | PC-3 | 302000 | 99800 | 3.03 |
| Example 9 | P-9 | 103200 | 29000 | 3.56 |
| Comparative Example 4 | PC-4 | 100200 | 31000 | 3.23 |
| Example 10 | P-10 | 284500 | 102400 | 2.78 |
| Comparative Example 5 | PC-5 | 284000 | 102500 | 2.77 |
| Example 11 | P-11 | 154300 | 56700 | 2.72 |
| Comparative Example 6 | PC-6 | 145000 | 53200 | 2.73 |
| Example 12 | P-12 | 294600 | 123700 | 2.38 |
| Example 13 | P-13 | 332500 | 127700 | 2.60 |

### Example 14

### Film Formation and Measurement of Re of Film

The norbornene-based polymers P-1 to P-13 and PC-1 to PC-6 were respectively mixed in the following composition.

| | |
|---|---|
| Norbornene-based polymer | 100 parts by mass |
| methylene chloride/methanol (92/8) | 320 parts by mass |
| Fine particles | 0.1 part by mass |
| (silicon dioxide: primary particle size 15 nm) | |

This was subjected to pressure filtration, and the resulting transparent dope was formed into a film by casting (clearance 700 μm) on a stainless steel plate (SUS plate) kept at 15° C./relative humidity of 60% by means of an applicator manufactured by YOSHIMITSU Co. After an elapse of a given time (peel start time), the solvent was evaporated to form a film on the SUS plate. Then, the load for vertically peeling a web with a width of 2 cm from the SUS plate at a speed of 200 mm/sec was measured with a load cell. At this step, the measurement was carried out in an airless environment at 25° C. and a relative humidity of 60%. The maximum peel load obtained was determined, and is expressed in terms of the peel load (gf/cm). Further, the residual solvent amount (mass %) of the film was determined by calculation from the mass of the film upon peeling, and the mass of the film after 3-hour drying at 120° C.

The presence or absence of the peel step unevenness was judged in the following manner. One side surface of the peel film is uniformly coated with black ink or the like without unevenness. Thus, the reflected image of transmission light from the surface on the opposite side from the coated surface was visually observed by changing the angle. Then, the judgment was done based on whether straight-line stripes or unevenness was observed or not. The evaluation was carried out based on criteria A to D.
A: Peel step unevenness was not observed at all;
B: Peel step unevenness was slightly observed, but no actual damage was caused;
C: Peel step unevenness was slightly observed, and was on the problematic level; and
D: Peel step unevenness was heavily observed over the entire surface, and was unfavorable.

The film was visually observed, and the surface conditions were evaluated as follows:
A: The film surface is smooth;
B: The film surface is smooth, but foreign matters are slightly observed;
C: Slight unevenness is observed on the film surface, and the presence of foreign matters are clearly observed; and
D: Unevenness is observed on the film, and a large number of foreign matters are observed.

The thickness of the resulting film was measured by means of a digital micrometer, and the thickness direction retardation Rth was measured with the foregoing method. From this value, Rth (Rth₅₉₀) at 590 nm in terms of 80 μm was determined. The result is shown in Table 2.

TABLE 2

| | Aryl | Peel | | Residual | | | | |
|---|---|---|---|---|---|---|---|---|
| | group | start | Peel | solvent | | Film | | |
| | content | time | load | amount | Peel step | surface | Rth₅₉₀ | |
| Example | (mol %) | (s) | (gf/cm) | (%) | unevenness | conditions | (nm) | Notes |
| P-1 | 0.5 | 200 | 9.8 | 41 | A | A | 215 | Invention |
| P-2 | 0.05 | 200 | 11.5 | 37 | B | B | 214 | Invention |
| P-3 | 1.0 | 200 | 9.5 | 39 | A | A | 210 | Invention |
| P-4 | 1.5 | 200 | 9.2 | 41 | A | A | 211 | Invention |
| P-5 | 0.5 | 200 | 9.7 | 39 | A | A | 213 | Invention |
| P-6 | 0.5 | 200 | 9.2 | 41 | A | A | 215 | Invention |
| PC-1 | 0 | 200 | 12.3 | 38 | C | C | 213 | Comparative |
| | | | | | | | | Example |
| PC-7 | 5.9 | 200 | 9.0 | 40 | A | A | 259 | Comparative |
| | | | | | | | | Example |
| P-7 | 0.5 | 200 | 10.0 | 41 | A | A | 285 | Invention |
| PC-2 | 0 | 200 | 12.6 | 43 | C | C | 281 | Comparative |
| | | | | | | | | Example |
| P-8 | 0.5 | 250 | 10.5 | 33 | A | A | 279 | Invention |
| PC-3 | 0 | 250 | 13.4 | 35 | C | C | 281 | Comparative |
| | | | | | | | | Example |
| P-9 | 0.15 | 180 | 11.0 | 36 | A | A | 276 | Invention |
| PC-4 | 0 | 180 | 12.5 | 34 | C | C | 274 | Comparative |
| | | | | | | | | Example |
| P-10 | 0.5 | 240 | 13.2 | 43 | A | A | 217 | Invention |
| PC-5 | 0 | 240 | 17.0 | 45 | C | C | 215 | Comparative |
| | | | | | | | | Example |
| P-11 | 1.0 | 200 | 10.7 | 39 | A | A | 243 | Invention |
| PC-6 | 0 | 200 | 13.2 | 42 | C | C | 242 | Comparative |
| | | | | | | | | Example |
| P-12 | 0.01 | 200 | 12.0 | 39 | B | B | 214 | Invention |
| P-13 | 2.00 | 200 | 9.5 | 40 | A | A | 219 | Invention |

The norbornene-based polymer films of the invention were found to be excellent in all respects of peel step unevenness and film surface conditions. In contrast, for the comparative samples of the invention, the peel load was large, and the peel step unevenness and the film surface conditions were also inferior.

As for the polymer film containing an aryl group in an amount in the range of 0.01 to 2.0 mol %, the Rth thereof is equal to the Rth of the film not containing an aryl group. Thus, only the peelability and the film quality can be improved. On the other hand, for the copolymer containing an aryl group copolymerized therein in an amount outside the range, the peelability is improved, but the Rth of the film increases, and departs from the original film performances.

From the description up to this point, the norbornene-based polymer in the invention can be said to be favorable in peelability, and high in film productivity.

### Example 15

The P-1 was formed into a film by casting in the same manner as in Example 14. The peeled film was cut into a piece 10 cm long and 10 cm wide, while containing the residual solvent. This was subjected to 15% fixed end monoaxial stretching at a temperature of 140° C. by means of an automatic stretching machine manufactured by IMOTO Seisakusho, resulting in a stretched film. The thickness of the film was measured by means of a digital micrometer, and the front retardation Re and the thickness direction retardation Rth were measured in the foregoing manner From the values, Re (Re₅₉₀) and Rth (Rth₅₉₀) at 590 nm were determined. As a result, it was found that Re₅₉₀=62 nm, and Rth₅₉₀=240 nm, respectively. The thickness of the film was found to be 60 μm. Incidentally, the step unevenness and the surface conditions of the resulting stretched film were favorable, and both were rated as A.

### Example 16

### Manufacturing of Polarizing Plate

The manufactured P-1 stretched film and a cellulose acylate film (Fuji TAC, manufactured by Fuji Photo Film Co., Ltd.) were immersed in a 1.5N aqueous solution of sodium hydroxide at 60° C. for 2 minutes. Thereafter, they were immersed in a 0.1N aqueous sulfuric acid solution for 30 seconds and then passed through a water-washing bath to obtain saponified P-1 stretched film and Fuji TAC.

According to Example 1 described in JP-A-2001-141926, a polyvinyl alcohol film (9X75RS, manufactured by Kuraray Co., Ltd.) having a thickness of 75 μm was stretched in a longitudinal direction by imparting peripheral velocity difference between two pairs of nip rolls, resulting in a polarizing film.

The polarizing plate thus obtained and the saponified P-1 stretched film were bonded with each other using a 3 mass % aqueous solution of PVA (PVA-117H, manufactured by Kuraray Co., Ltd.) as an adhesive so as to make the angle between the longitudinal directions of the films 45° in a layer configuration of “saponified P-1 stretched film/polarizing film/saponified Fuji TAC”, thereby to manufacture a polarizing plate Pol-1.

### Example 17

### Manufacture and Evaluation of Liquid Crystal Display Device

Of two pairs of polarizing plates set with a liquid crystal layer interposed therebetween in each of 26-inch and 40-inch liquid crystal display devices (manufactured by Sharp Corporation) using VA type liquid crystal cells, the polarizing plate at one side on the observer side was released. Instead, the polarizing plate Pol-1 was bonded by the use of an adhesive thereto so that TAC faces the observer side. Arrangement was achieved so that the transmission axis of the polarizing plate on the observer side was orthogonal to the transmission axis of the polarizing plate on the backlight side. Thus, liquid crystal display devices were manufactured. The resulting liquid crystal display devices were observed for light leakage and color unevenness occurring in the black display state, and the in-plane uniformity. The liquid crystal display devices including the polarizing plate Pol-1 of the invention incorporated therein did not show changes in color tone, and were very excellent.

### Comparative Example 8

The PC-7 was formed into a film by casting in the same manner as in Example 15. The Re and the Rth were measured in the foregoing manner. At 60 μm, it was found that Re₅₉₀=82 nm, and Rth₅₉₀=290 nm. This was treated in the same manner as in Example 14, to manufacture a polarizing plate, which was incorporated in a liquid crystal display device in the same manner as in Example 17. This showed changes in color tone, and was inferior in image quality as compared with the devices of Example 17.

This is considered to be due to too high Rth thereof.

A norbornene-based polymer prepared by copolymerizing aryl group-containing norbornene-based monomers of the present invention is excellent in peelability during film manufacturing, and is excellent in film productivity. Further, the film of the invention is excellent from the viewpoints of the peeling step unevenness, and film surface conditions. It is possible to improve the peelability leading to the film productivity without substantially changing the property of the film manufactured without copolymerizing the aryl group-containing norbornene-based monomers.

What is claimed is:

1. A norbornene-based polymer, comprising:
a repeating unit represented by formula (I) in an amount of from 0.01 to 2.00 mol % based on a total amount of repeating units: 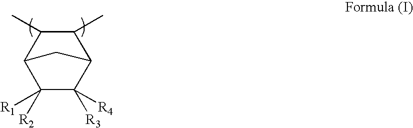
wherein R¹, R², R³ and R⁴ each independently represents a hydrogen atom, a halogen atom, a methyl group, or an aryl group which may have a substituent, provided that at least one of R¹, R², R³ and R⁴ represents an aryl group which may have a substituent.

2. The norbornene-based polymer according to claim 1, further comprising:
a repeating unit represented by formula (II) in an amount of from 98.00 to 99.99 mol % based on a total amount of repeating units: 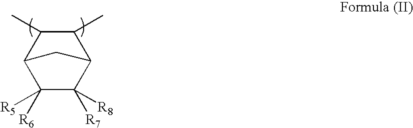
wherein R⁵, R⁶, R⁷ and R⁸ each independently represents a hydrogen atom or a functional substituent selected from the group consisting of —(CH₂)ₘ—OC(O)—R″, —(CH₂)ₘ—OH, —(CH₂)ₘ—C(O)—OH, —(CH₂)ₘ—C(O)OR″, —(CH₂)ₘ—OR″, —(CH₂)ₘ—OC(O)OR″, —(CH₂)ₘ—C(O)R″, and —(CH₂)ₘ—O—(CH₂)_{m′}—OH, where m and m′ each independently represents 0 to 10, R″ represents a linear or branched alkyl group having from 1 to 10 carbon atoms, provided that at least one of R⁵, R⁶, R⁷ and R⁸ represents the functional substituent, and R⁵ and R⁸ may be combined with carbon atoms to which R⁵ and R⁸ are attached to form an anhydride or a dicarboxyimide group.

3. The norbornene-based polymer according to claim 1,
wherein R¹, R², R³, and R⁴ in the formula (I) each independently represents a hydrogen atom or a phenyl group, and at least one of R¹, R², R³, and R⁴ represents a phenyl group.

4. The norbornene-based polymer according to claim 3, wherein one of R¹, R², R³, and R⁴ in the formula (I) represents a phenyl group.

5. The norbornene-based polymer according to claim 2,
wherein R⁵, R⁶, R⁷, and R⁸ in the formula (II) each independently represents a hydrogen atom or —CH₂—OC(O)—R″, and at least one of R⁵, R⁶, R⁷, and R⁸ is —CH₂—OC(O)—R″, where R″ represents a linear or branched alkyl group having from 1 to 10 carbon atoms.

6. A film, comprising:
the norbornene-based polymer according to claim 1.

7. The film according to claim 6, satisfying the following expression:
30 nm≦Re₅₉₀≦200 nm
wherein Re₅₉₀ represents an in-plane retardation at a wavelength of 590 nm.

8. A polarizing plate, comprising:
the film according to claim 6.

9. A liquid crystal display device, comprising:
the polarizing plate according to claim 8.
